(19) United States
(12) Patent Application Publication
(10) Pub. No.: US 2016/0123097 A1
(43) Pub. Date: May 5, 2016

(54) Method of Treating Flowback Fluid from a Well

(71) Applicants: Jerry W. Noles, JR., Blanchard, OK (US); Alex J. Watts, Rayville, LA (US)

(72) Inventors: Jerry W. Noles, JR., Blanchard, OK (US); Alex J. Watts, Rayville, LA (US)

(21) Appl. No.: 14/527,390

(22) Filed: Oct. 29, 2014

(51) Int. Cl. E21B 21/06; C02F 1/00; C02F 9/00

(52) U.S. Cl. CPC E21B 21/068; C02F 9/00; C02F 1/008; C02F 1/66

(57) ABSTRACT

A method and apparatus for treating flow back fluid from a well after a well completion process is disclosed. The method includes the steps of maintaining the pH of the flow back fluid at a certain level and introducing an oxidizing agent into the fluid flow. The flow back fluid which typically contains at least water, oil and solids is passed through a tubing bundle, an oil/water separator, and a liquid solid separating device. Apparatus is also disclosed for carrying out the method.

### BACKGROUND OF INVENTION

1. Field of the Invention

This invention is directed to a method and apparatus for treating flow back fluids from an oil or gas well after a completion process has been performed on an oil or gas well. An example is treating the flow back fluid after a fracturing process. The flow back fluid typically includes mostly water with added chemicals, proppant, other solids and salt water from the formation being treated.

Within recent years the oil and gas industry has developed the use of hydraulic fracturing to produce what was once considered nonproductive oil and gas formations. This hydraulic fracturing technology requires the use of high volumes of water to be pumped into the wells under tremendous rates and pressures to pry the rock apart allowing the oil and gas that is trapped within the matrix of these formations to migrate to the wellbore and production casing. Although the use of this technology has allowed high volumes of oil and gas recovery from these formations, the use of these large volumes of water has been widely scrutinized. Because the water that is used during these fracturing operations must be clean and free from contaminates current technologies use fresh water sources that are normally used for irrigation and human consumption. The use of these fresh water supplies has begun to have an impact on the availability of fresh water for human consumption and irrigation. Although the water that is pumped into these formations is recovered over the production life of the oil and gas well the water becomes contaminated with chemicals from the fracturing process and minerals that are leached from the producing reservoir during the production of the well. Most oil and gas reservoirs were created from decomposed organic matter generated from oceanic seabed. This fresh water mixes with the salt water that is typically produced from the hydrocarbon formations making both the frac water and the formation water unsuitable for human consumption or reuse for hydraulic fracturing.

2. Description of Related Art

Currently there are several methods in use for handling flow back fluids. One such method is that the water that is produced or that flows back from the well is then disposed of by pumping it into deep nonproductive oil and gas formations. This cycle is repeated for each well and can use hundreds of thousands of barrels for each operation. This process and reduced fresh water supplies have generated a need for an economic technology that can clean these large volumes of water generated by the flow-back and production of these wells to allow the water to be reused instead of disposed of thereby reducing the burden that is placed on fresh water supplies. The industry has tried multiple technologies to clean and repurpose this water and although somewhat successful in certain areas the complexity of the water from area to area and even well to well has made it almost impossible for companies to provide a stable solution that can address these wide variations of water conditions. The technology must be capable of handling high volumes of suspended solids such as polymers and chemicals as well as the smaller dissolved solids such as iron, salts and other minerals. The problem with this wide range in particle size and volume of solids has made handling this material very difficult. And although technologies such as Reverse Osmosis Membrane systems or molecular filters have been used to separate these small particles from the water they are not designed to handle high levels of solids or chlorides. This is further compounded by the nature of very small droplets of oil being entrained with in the body of the water. This oil that coexists within this produced water can be up to five percent by volume and causes these Membranes to degrade and fail. Therefore the industry has been left with using methods that were developed for wastewater treatment of municipals. These technologies use large capacity retention ponds and polymers along with microbes to digest and separate the solids from the water. And although this technology has worked for years in the municipal areas it was never designed to handle the types of materials associated with produced oil and gas water.

That combined with the large retention requirements and the high volumes that need to be processed has made these techniques of treatment and settling mostly ineffective for this application. Therefor the need to develop a water treatment technology that can handle these high volumes of both liquid and solids that is not affected by the entrained oil and does not require large retention reservoirs for settling of the solids is needed.

### BRIEF SUMMARY OF THE INVENTION

The present invention is a method and apparatus for treating flow back fluids that include the following.

First the pH level of the flow back fluid is measured and adjusted to be above approximately 7.5. At this point a small volume of an oxidizing agent such as hydrogen peroxide is introduced into the water until the redox potential reaches a value of at least 600 my. This will cause any iron in the fluid to solidify. Additionally, a varying amount of hydroxyl free radicals are produced which destroys and converts many of the dissolved solids.

The flow back fluid is then passed through a tubing bundle which may include a plurality of straight sections interconnected by 180° tubular bends which further aids the oil/water separation process.

From the tubing bundle the fluid is directed to an oil/water separating unit which may include a coalescing element which may include a plurality of coalescing plastic tubes in removable baskets which facilitate the formation of large oil droplets that will float to the top of the separator. From there, the separated water is directed to a vacuum rotary drum filter for further purification. Water from the vacuum rotary drum filter may be passed through a reverse osmosis membrane for drinking or other purposes. Also, water can be collected from the vacuum rotary drum filter for reuse in a subsequent fracturing procedure.

In one embodiment, the rotary vacuum filter that uses an expendable diatomaceous earth can be replaced with a non-expendable media that is designed to perform the same level of particle size reduction as a rotary vacuum. This media can further be incorporated into a vacuum conveyor. A large pore sized vacuum belt can have a membrane added to surface of the belt to provide a reduced pore space that can be used to recover particles that are both suspended and dissolved. These filters provide an excellent platform to handle the large volumes of solids that can be associated with the water such as salts or other materials. This membrane solids recovery can function much in the way that a reverse osmosis functions but eliminate the mechanical fouling that occurs when high solids are present within the water. This recovery of salt can be further improved with the use of chemicals.

In a further embodiment a solvent such as acetone or an alcohol can be introduced into the fluid stream to provide a full or partial Asiatrop effect. Some solvents can have such a strong attraction to the hydrogen bond of the water that anything that is attached or partially attached becomes pushed out of phase and precipitates out almost instantly. A full asiatrope has such a strong polarity to this bond that it becomes part of the water composition requiring a staged distillation to recover or disassociate from the water itself. However, solvents or alcohols that have a partial asiatrope effect can be used to push the dissolved solids such as salts that have the weakest charge association out of phase. These alcohols have a weaker charge association to the hydrogen. Thereby if properly selected they may have a much lower boiling point than the water allowing them to be fully recovered under the reduced atmosphere or within the vacuum stage of this process. This boiling point may occur at a much lower temperature than the water even at an ambient value that would minimize the amount of energy required to distill the solvent or alcohol without vaporizing the water. This differential in boiling point between the water and the solvent would allow the solvent to be recovered and condensed within a vapor during the vacuum effect allowing separation between it and the water. This would also allow the solvent to be repetitively recycled for the salt extraction. Doing this at the proper time would allow these salts to be recovered and filtered with the other suspended solids that are recovered during the filtration portion of the vacuum filter.

### BRIEF DESCRIPTION OF THE SEVERAL VIEWS OF THE DRAWING(S)

FIG. 1A is a schematic view of a portion of the treatment process and apparatus according to an embodiment of the invention.

FIG. 1B is a schematic view of a second portion of the treatment process and apparatus according to an embodiment of the invention.

FIG. 2 is a schematic view showing the solvent injection system.

### DETAILED DESCRIPTION OF THE INVENTION

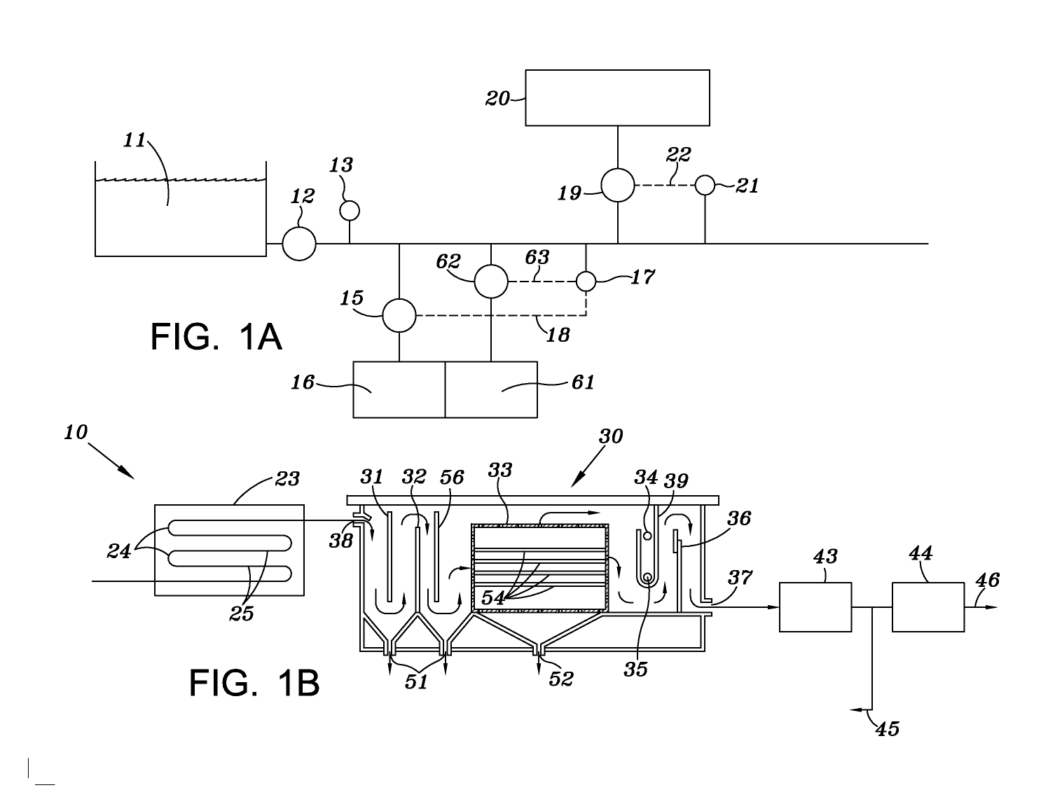

Referring to FIG. 1A, a reservoir 11 for flow back fluid from a well completion process such as fracturing is provided at the well site to contain the flow back fluid which mainly consists of water. It also includes dissolved solids, proppant, solids and well completion chemicals. In addition to the fresh water used for fracing, salt water from the formation is also typically produced back.

Flow back fluid is conveyed from reservoir 11 by a suitable pump 12. A flow meter 13 measures the flow rate of the fluid. A dual reservoir 16 and 61 for acidic and alkali mixtures is connected to metering pumps 15 and 62 which may be variable speed electric pumps to introduce the appropriate amount of mixture to adjust the pH of the fluid to about 7.5. The pH of the fluid is monitored by a sensor 17 and a feedback control circuit 18 and 63 may send a signal to the metering pumps 15 and 62 to adjust the amount of material being added. An example of a metering system is disclosed in U.S. Patent Application Publication No. 2012/0127822A1, the entire contents of which is hereby incorporated herein by reference thereto.

Once the pH of the fluid is at about 7.5, a small amount of an oxidizing agent such as hydrogen peroxide is introduced into the fluid by a metering pump 19 which is connected to a reservoir 20 containing the oxidizing agent. A sensor 21 measures the oxidative redox potential of the water and the amount of added oxidizing agent is adjusted by a signal 22 to metering pump so that the level reaches a value of at least 600 mw with the pH at 7.5 plus or minus one.

At a PH above 7 the oxidizing agent begins to convert the soluble Fe2 to its insoluble form (Fe3) thus allowing the iron to be more readily removed by downstream means. The treatment also aids in destroying bacteria and dissolved solids such as organic pollutants, BOD, COD and reducing toxicity levels. This oxidative process additionally disrupts the water by releasing an oxygen molecule during the iron conversion process and producing a varying amount of hydroxyl free radicals. This not only destroys and converts many of the dissolved solids but it causes a reduction in the density of the water thereby helping the small droplets of oil that are contained within the water to separate away from the main body of the water.

After the addition of the oxidizing agent, the fluid is passed through a tubing bundle 23 shown in FIG. 1B similar to the one disclosed in the above identified patent application publication. It includes a plurality of straight sections 25 and a plurality of 180° elbow bends 24. This further encourages the oil and solid particles to disassociate from the water and eliminates the need for retention tanks commonly associated with conventional water treatment.

From the tubing bundle, the fluid is directed into an oil water separator unit 30 that includes a coalescing unit 33 that includes a plurality of coalescing tubes 54 made from polypropylene. Unit 33 may be an open basket with tubes 54 positioned within the basket that is removably placed within the separator.

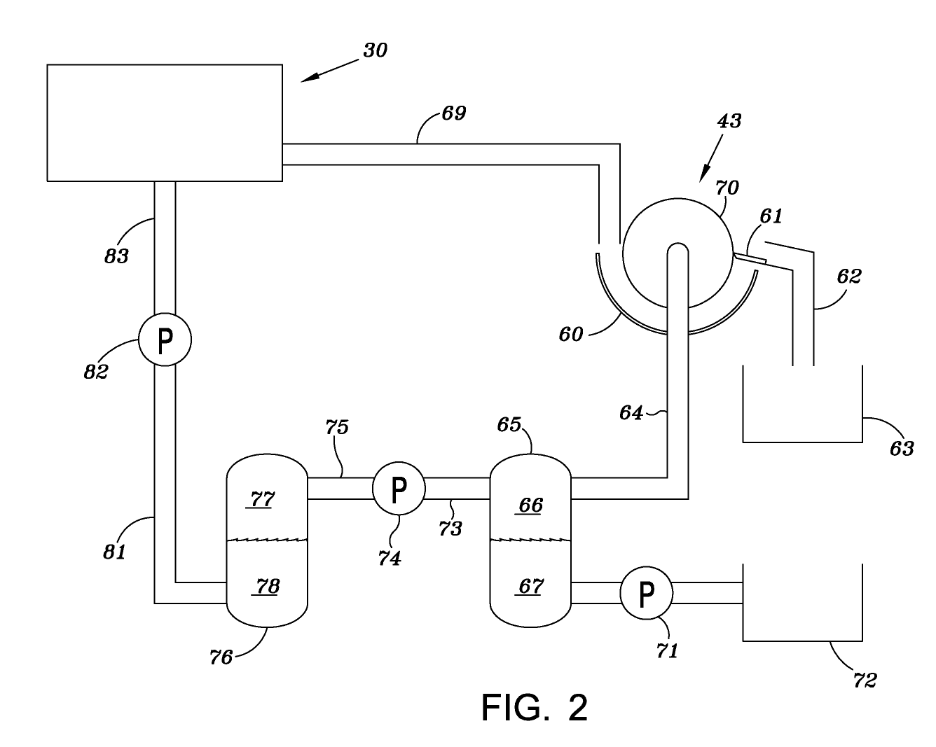

The fluid enters unit 30 at 38 and is directed under a baffle plate 31 and over a weir plate 32. A second baffle plate 56 is positioned between weir plate 32 and coalescing unit 33. Coalescing tubes 54 promote the oil to form large droplets which rise to the top. Oil is removed from the top of the separator through outlet 34. Water is directed under U-shaped baffle 39 and flows over an adjustable baffle 36. Water is removed from separator 30 through outlet 37. Any water that accumulates in baffle 39 exits out through port 35. Solids that accumulate at the bottom of the separator can be removed through outlets 51 and 52. An example of a separator is the TPL Phase 3 coalescing Type Oil/Water Separator sold by Flo Trend Systems Inc. of Houston, Tex. Water exiting the separator is next directed to a conventional vacuum rotary drum filter or drying belt 43 that has been specially prepared using a mixture of Diatomaceous Earth and Activated Charcoal. However this system allows for a variety of different mediums to be used for mixture with the diatomaceous earth that can provide for different function, such as materials that are engineered to target specific solvents (ionic exchange resins) or other materials contained in the fluid for further processing. Because the oxidizing agent has begun to cause the particles to agglomerate around the iron that has been converted from soluble to insoluble they are now of a colloidal size and can be filtered from the fluid medium while the smaller particles are trapped within the charcoal and the diatomaceous earth The larger solids such as polymers and sand are scraped from the outside of the vacuum rotary drum filter with a self-cleaning scrapper blade 61 while the vacuum pulled from the inside of the drum dries these solids as shown in FIG. 2. The exiting water is now suitable for further desalination with the use of a reverse osmosis membrane 44 for drinking or other purposes or the water can be directed straight to additional fracturing operations thru conduit 45. This system is scalable and requires low energy and generates high volumetric through puts.

A system for injecting a solvent into the treated fluid is shown in FIG. 2. A pressure pot 76 contains an upper layer 77 of air and a lower layer 78 of solvent. Solvent is pumped via conduit 81, pump 82 and conduit 83 into the discharge end of the oil water separator unit 30. Fluid which may contain solids is directed into the liquid trough area 60 of a vacuum rotary drum filter 43 via conduit 69. Rotary drum picks up fluid from trough 60. A scrapper 61 directs solids through deflector 62 into a container 72. A conduit 64 is connected to the vacuum chamber of the vacuum rotary drum filter and leads to a vacuum pot 65 having an upper layer 66 of air and solvent and a lower layer 67 of water. Water is removed from the vacuum pot 65 to a water storage container 72 via pump 71. Air and solvent is removed from the vacuum pot via a vacuum pump 74 to pressure pot 76. Solvent 78 condenses in the bottom of the pressure pot and air collects at the top 77. Solvent 78 can now be recycled into the oil water separating unit 30.

As the solvent asiatrops with the water, dissolved salts immediately precipitate out of solution. These salts are then removed by the vacuum rotary drum filter. However, once the solvent (having a lower boiling point than water) enters into the reduced atmosphere generated by the vacuum rotary driver filter it vaporizes and separates from the water. This vapor along with the air condenses on the downstream side of the vacuum pump 74 in pressure pot 76 from which it can be reintroduced into the water for a continuous desalination process with low chemical consumption.

Although the present invention has been described with respect to specific details, it is not intended that such details should be regarded as limitations on the scope of the invention, except to the extent that they are included in the accompanying claims.

We claim:

1. A method of treating flow back fluid from a well completion process wherein the flow back fluid contains water, solids, dissolved solids and oil comprising:
a) conveying the flow back fluid via a conduit,
b) maintaining the pH level of the fluid back fluid above about 7.5,
c) adding an oxidizing agent to the flow back fluid until the redox potential of the flow back fluid reaches a value of at least 600 my,
d) passing the flow back fluid through an oil/water separator having a coalescing unit,
e) directing the water from the separator to a liquid solid separating device; and outputting the water from the liquid solid separating device.

2. A method according to claim 1 further including adding a solvent or alcohol to the water.

3. A method according to claim 1 further including directing the water from the liquid solid separating device to a desalting device.

4. A method according to claim 3 wherein the desalting device is a reverse osmosis membrane apparatus.

5. A method according to claim 1 wherein the liquid solid separating device is a vacuum rotary drum filter including a filter medium coated with a mixture of powdered charcoal and diatomaceous earth.

6. A method according to claim 5 further including compressing or condensing solvent vapor created in the vacuum rotary drum filter and reintroducing the solvent into the water before the water enters the vacuum rotary drum filter.

7. A method according to claim 1 further including passing the flow back fluid through a tubing bundle prior to the flow back fluid entering the oil/water separator.

8. Apparatus for treating flow back fluid from a well after a completion process has been performed comprising:
a reservoir for containing a substance which will adjust the pH of the flow back fluid,
a metering device for dispensing a controlled amount of the substance into the flow back fluid,
a tubing bundle having an inlet and an outlet through which the flow back fluid flows,
an oil/water separator having an inlet and an outlet connected to the outlet of the tube bundle; and
a liquid solid separation device having an inlet connected to the outlet of the oil/water separator.

9. The apparatus of claim 8 further including a reservoir containing an oxidizing agent and a metering pump for introducing the oxidizing agent into the flow back fluid.

10. The apparatus of claim 9 further including a redox potential meter.

11. The apparatus of claim 8 further including a reservoir for a solvent and a metering pump for introducing the solvent into the flow back fluid.

12. The apparatus of claim 8 wherein a reverse osmosis membrane apparatus is connected to an outlet of the liquid solid separating device.

13. Apparatus as claimed in claim 8 wherein the liquid solid separating device is a vacuum rotary drum filter including a filter medium comprising a mixture of activated charcoal and diatomaceous earth.

14. Apparatus as claimed in claim 8 wherein the oil/water separator includes an oil coalescing unit comprising a plurality of tubes.

15. A method as claimed in claim 1 wherein the oxidizing agent is hydrogen peroxide.
